(19) United States
(12) Patent Application Publication
(10) Pub. No.: US 2024/0418238 A1
(43) Pub. Date: Dec. 19, 2024

(54) TRANSMISSION BELT FOR LENS

(71) Applicant: TILTA INC., Burbank, CA (US)

(72) Inventors: Wenping Zeng, Shenzhen (CN); Kefeng Zhou, Shenzhen (CN)

(21) Appl. No.: 18/467,632

(22) Filed: Sep. 14, 2023

(30) Foreign Application Priority Data
Jun. 13, 2023 (CN) 2023209401651

(51) Int. Cl. F16G 1/28; F16G 1/14; F16G 1/21

(52) U.S. Cl. CPC F16G 1/28; F16G 1/14; F16G 1/21

(57) ABSTRACT

Aspects of the present disclosure are directed to a composite transmission belt that can be removably attached to a camera lens such that a control ring of the camera lens can be controlled by a driving device via the transmission belt.

### CROSS-REFERENCE TO RELATED APPLICATIONS

The present Application for patent claims priority to and the benefit of pending Chinese Application No. 2023209401651, filed Jun. 13, 2023, and hereby expressly incorporated by reference herein as if fully set forth below in its entirety and for all applicable purposes.

### TECHNICAL FIELD

The present disclosure relates to the technical field of photographic auxiliary devices, in particular to a transmission belt for a lens.

### INTRODUCTION

At present, in the field of photography, there are some devices (such as lenses, etc.) whose parameters (e.g., focus, aperture) need to be adjusted through the rotation of an outer ring (e.g., control ring) of the device. Often the device provides anti-slip features (e.g., anti-slip straight lines) for rotating the outer ring. Some cameras have one or more external control rings that are designed with a textured surface or rubberized material that provides a better grip and reduces the risk of slipping. However, a typical outer ring cannot support the use of motors and other driving devices for the mechanical driving of the outer ring.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a form as a prelude to the more detailed description that is presented later.

Therefore, the present disclosure aims to achieve the objective of connecting an external driving device by means of a composite transmission belt.

In view of the shortcomings mentioned above, the present disclosure provides a composite transmission belt, which can solve the limitation of the driving control of photographic devices. In order to achieve the above object, the present disclosure provides the following schemes:

In some aspects, a composite transmission belt includes a transmission part and a mounting part. The transmission part and the mounting part are connected (e.g., glued) into a whole unit. The transmission part can be made of a wear-resistant material, such as nylon or flexible metal. The transmission part is provided with a meshing area and an adjusting area, the meshing area is arranged above the transmission part and is composed of a plurality of same tooth profiles, and the meshing area can mesh with a driving device (e.g., a drive motor). The adjusting area is arranged at one end of the transmission part, and the adjusting area is composed of a groove and an adjusting meshing area. The meshing area can be flexibly deformed into a circle, the meshing area is on the outside of the circle, and an end of the meshing area is connected to the inside of the groove of the adjusting area and meshes with the adjusting meshing area inside the adjusting area, such that the composite transmission belt becomes circular.

The mounting part is composed of a non-slip and flexible material, such as silica gel. The mounting part is provided with an anti-slip texture, and can be attached to a device stably after being flexibly deformed into a circle.

### BRIEF DESCRIPTION OF THE DRAWINGS

FIG. 1 is a schematic diagram of a transmission belt according to some aspects of the present disclosure.

FIG. 2 is a schematic diagram of the transmission belt formed in a loop according to some aspects of the present disclosure.

FIG. 3 is a schematic diagram of the transmission belt installed on a camera lens according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

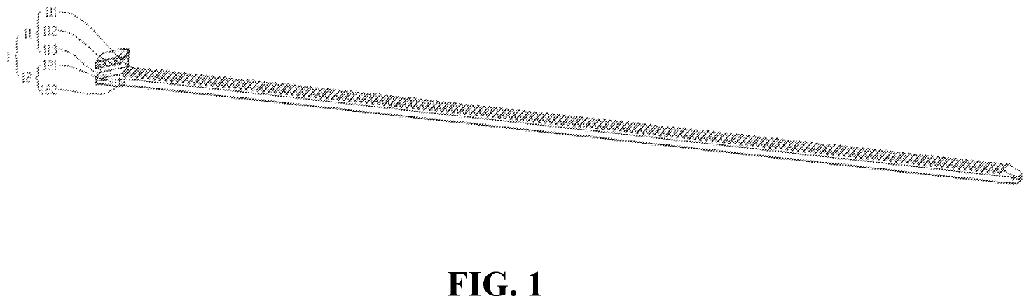

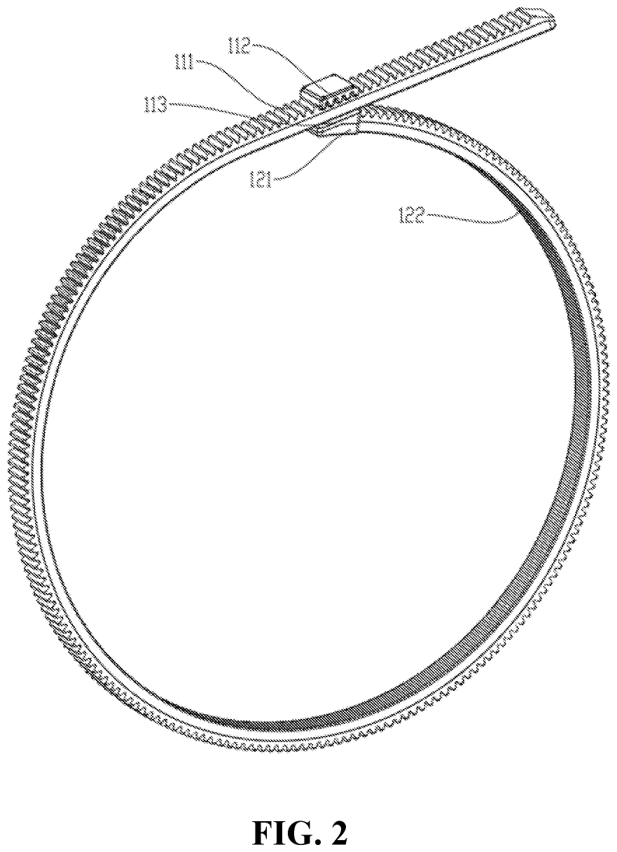

The present disclosure will be described in conjunction with the accompanying drawings. As shown in FIGS. 1 and 2, the present disclosure provides a composite transmission belt 1, which includes a transmission part 11 and a mounting part 12. A portion of the transmission part 11 (112) can be attached (e.g., glued) to an upper end or side (as shown in FIG. 1) of the mounting part 12. In some aspects, the transmission part 11 and the mounting part 12 can be formed as a single piece.

The transmission part 11 includes a meshing area 111, an adjusting meshing area 112, and a groove 113 (slot). The meshing area 111 includes a plurality of protruding elements (e.g., teeth with the same profile), and the meshing area 111 can be flexibly deformed (e.g., bent) into a circle (e.g., as a loop around a lens as shown in FIG. 2). The meshing area 111 is on the outside surface of the circle, and the end (or a part) of the meshing area 111 is connected to (or pass) the inside of the groove 113 (e.g., a slot). The teeth of the meshing area 111 mesh (e.g., interlock) with the corresponding teeth in the adjusting meshing area 112 inside the adjusting area, so that the composite transmission belt becomes circular in shape. The size of the circle formed by the transmission part 11 can be adjusted by moving the meshing area 111 relative to the meshing area 112 in the groove 113.

In some aspects, the mounting area 12 includes a flexible area 121 and an anti-slip area 122. The anti-slip area is arranged at the bottom (as shown in FIG. 1), and can be stably attached to the device (e.g., a lens with the composite transmission belt 1 installed as shown in FIG. 2).

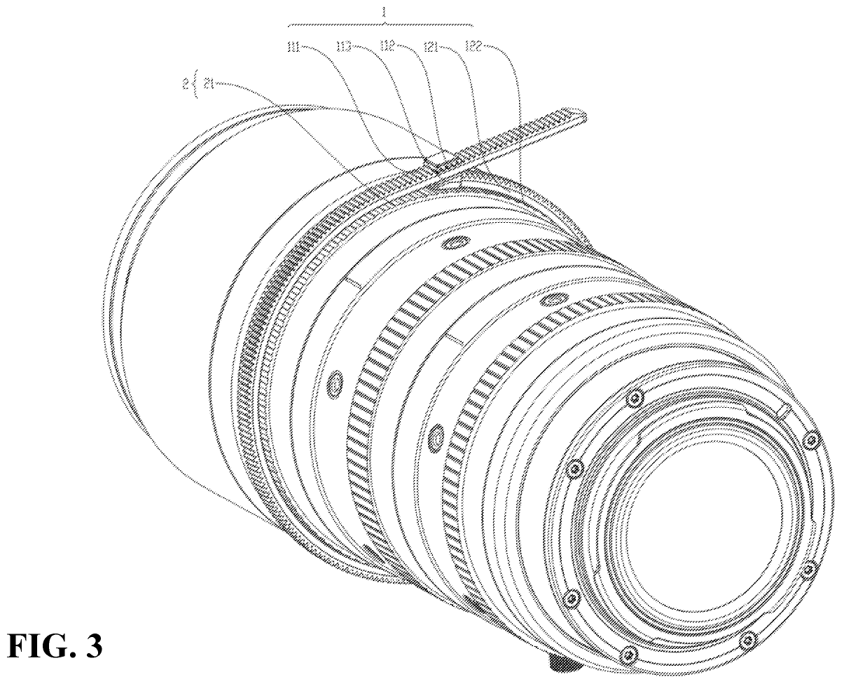

As shown in FIGS. 1-3, the composite transmission belt 1 is around the lens 2 after being deformed (e.g., wrapped around the lens 2), the mounting area (e.g., anti-slip area 122) is stably attached or secured to the lens 2, the end (or a portion) of the transmission part 11 and the flexible area 121 are arranged in the groove 113, and the transmission part 11 meshes with the adjusting meshing area 112. Further, the composite transmission belt 1 is connected to lens 2, and a meshing area 111 for power or end-to-end transmission is formed on the outer ring of the lens 2. Further, the transmission meshing area 111 can be connected to a corresponding driving device (e.g., motors). For example, the driving device can drive (or rotate) a control ring of the lens 2 through the composite transmission belt 1.

In some aspects, the present disclosure provides a transmission belt that comprises a transmission part and a mounting part. The transmission part can be attached (e.g., glued) on an upper end of the mounting part. The transmission part can be composed of a wear-resistant material, such as nylon or flexible metal. The transmission part can be provided with a first meshing area and an adjusting area. The first meshing area is arranged above the transmission part and comprises a plurality of teeth, and the first meshing area can be used to mesh with a driving device. The adjusting area can be arranged at one end of the transmission part, and the adjusting area comprises a groove and an adjusting meshing area. The first meshing area can be flexibly deformed into a circle, the first meshing area is on the outside of the circle, and a portion of the first meshing area is connected to the inside of the groove of the adjusting area and meshes with the adjusting meshing area inside the adjusting area, such that the transmission belt becomes circular. The mounting part can be composed of a non-slip and flexible material, such as silica gel. The mounting part can be provided with an anti-slip texture, and can be attached to the driving device stably after being flexibly deformed into a circle.

In some aspects, a tooth type of the first meshing area can be an involute tooth type or a circular arc tooth type. In some aspects, the transmission belt can be deformable into a driving ring with an adjusting diameter. In some aspects, the transmission belt can include two materials. The transmission part can have wear resistance and lubrication properties. The mounting part can have flexibility and anti-skid properties.

In some aspects, a transmission belt for a lens includes: a transmission part comprising a meshing area; a mounting part connected to an end of the transmission part; and an adjusting part on the mounting part and forming a slot between the adjusting part and the mounting part. The transmission part can be bendable to be installed in the slot between the mounting part and the adjusting part. The transmission part can include a meshing area configured to mesh with the adjusting part. The meshing area can include a plurality of teeth configured to mesh with the corresponding teeth of a driving device (e.g., drive motor) of the lens. The adjusting part can include a plurality of teeth configured to mesh with a portion of the meshing area of the transmission part in the slot. The mounting part can include a non-slip and flexible material. The mounting part can be provided with an anti-slip texture on a side facing the lens.

In some aspects, the transmission part can include a wear-resistant material selected from the group consisting of nylon or flexible metal. In some aspects, the transmission belt can be composed of two materials. For example, the transmission part includes a material with wear resistance and lubrication properties, and the mounting part includes a material with flexibility and anti-skid properties.

In some aspects, a method of using a transmission belt on a lens is provided. The method attaches a transmission belt around a control ring of a lens. The transmission belt includes: a transmission part comprising a first meshing area; a mounting part connected to an end of the transmission part; and an adjusting part on the mounting part, and forming a slot between the adjusting part and the mounting part. The transmission part is wrapped around the lens to be installed in the slot between the mounting part and the adjusting part. The first meshing area comprises a plurality of teeth configured to mesh with the corresponding teeth of a driving device of the lens. The adjusting part comprises a plurality of teeth configured to mesh with the teeth on a portion of the first meshing area of the transmission part in the slot. The mounting part comprises a non-slip and flexible material. The mounting part is provided with an anti-slip texture on a side facing the lens.

In some aspects, the method bends the transmission part to form a loop around the control ring, a first portion of the transmission part overlapping a second portion of the transmission part. In some aspects, the method adjusts a position of the transmission part inside the slot to adjust the diameter of the loop formed by the transmission part around the control ring.

The above are only the exemplary embodiments of the present disclosure, and are not intended to limit the present disclosure. Any modification, equivalent substitution and improvement made within the spirit and principle of the present disclosure should fall within the protection scope of the present disclosure.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof.

It is to be appreciated that the present disclosure is not limited to the exemplary terms used above to describe aspects of the present disclosure. For example, bandwidth may also be referred to as throughput, data rate or another term.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A transmission belt, comprising a transmission part and a mounting part, wherein
the transmission part is glued on an upper end of the mounting part;
the transmission part is composed of a wear-resistant material, such as nylon or flexible metal;
the transmission part is provided with a first meshing area and an adjusting area, the first meshing area is arranged above the transmission part and comprising a plurality of teeth, and the first meshing area is meshing with a driving device;
the adjusting area is arranged at one end of the transmission part, and the adjusting area comprises a groove and an adjusting meshing area;
the first meshing area can be flexibly deformed into a circle, the first meshing area is on the outside of the circle, and a portion of the first meshing area is connected to the inside of the groove of the adjusting area and meshes with the adjusting meshing area inside the adjusting area, such that the transmission belt becomes circular;
the mounting part is composed of a non-slip and flexible material, such as silica gel; and
the mounting part is provided with an anti-slip texture, and can be attached to the driving device stably after being flexibly deformed into a circle.

2. The transmission belt of claim 1, wherein a tooth type of the first meshing area is an involute tooth type or a circular arc tooth type.

3. The transmission belt of claim 1, wherein the transmission belt is deformable into a driving ring with an adjusting diameter.

4. The transmission belt of claim 1, wherein the transmission belt comprises two materials, the transmission part has wear resistance and lubrication properties, and the mounting part has flexibility and anti-skid properties.

5. A transmission belt for a lens, comprising:
a transmission part comprising a meshing area;
a mounting part connected to an end of the transmission part; and
an adjusting part on the mounting part and forming a slot between the adjusting part and the mounting part,
wherein:
the transmission part being bendable to be installed in the slot between the mounting part and the adjusting part;
the transmission part comprises a meshing area configured to mesh with the adjusting part, the meshing area comprises a plurality of teeth configured to mesh with corresponding teeth of a driving device of the lens;
the adjusting part comprises a plurality of teeth configured to mesh with a portion of the meshing area of the transmission part in the slot;
the mounting part comprises a non-slip and flexible material; and
the mounting part is provided with an anti-slip texture on a side facing the lens.

6. The transmission belt of claim 5, wherein the transmission part comprises a wear-resistant material selected from the group consisting of nylon or flexible metal.

7. The transmission belt of claim 5, wherein the transmission belt is composed of two materials, the transmission part comprises a material with wear resistance and lubrication properties, and the mounting part comprises a material with flexibility and anti-skid properties.

8. A method of using a transmission belt on a lens, comprising:
attaching a transmission belt around a control ring of a lens, the transmission belt comprising:
a transmission part comprising a first meshing area;
a mounting part connected to an end of the transmission part; and
an adjusting part on the mounting part, and forming a slot between the adjusting part and the mounting part,
wherein:
the transmission part is wrapped around the lens to be installed in the slot between the mounting part and the adjusting part;
the first meshing area comprises a plurality of teeth configured to mesh with corresponding teeth of a driving device of the lens;
the adjusting part comprises a plurality of teeth configured to mesh with the teeth on a portion of the first meshing area of the transmission part in the slot;
the mounting part comprises a non-slip and flexible material; and
the mounting part is provided with an anti-slip texture on a side facing the lens.

9. The method of claim 8, wherein the attaching the transmission belt around a control ring of a lens comprises:
bending the transmission part to form a loop around the control ring, a first portion of the transmission part overlapping a second portion of the transmission part.

10. The method of claim 9, further comprising:
adjusting a position of the transmission part inside the slot to adjust a diameter of the loop formed by the transmission part around the control ring.
